(19) United States
(12) Patent Application Publication
(10) Pub. No.: US 2009/0134035 A1
(43) Pub. Date: May 28, 2009

(54) Method for forming platinum aluminide diffusion coatings

(75) Inventor: Michael J. Minor, Arlington, TX (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/888,713

(22) Filed: Aug. 2, 2007

(51) Int. Cl. C25D 3/56; B05D 3/00

(52) U.S. Cl. 205/257; 427/343

(57) ABSTRACT

A method for forming a platinum aluminide coating comprising forming a platinum-containing coating on the substrate, and performing a diffusion coating process with the use of an aluminum-based compound and a halide activator, each having a sulfur concentration of less than about 20 parts-per-million by weight.

### CROSS-REFERENCE TO RELATED APPLICATION(S)

Reference is hereby made to co-pending patent application Ser. No. ______ filed on even date (attorney docket U73.12-0176/PA-0000628-US), and entitled “Method For Forming Aluminide Diffusion Coatings”; and to co-pending patent application Ser. No. ______ filed on even date (attorney docket U73.12-0177/PA-0000627-US), and entitled “Method For Forming Active-Element Aluminide Diffusion Coatings”.

### BACKGROUND

The present invention relates to methods for coating metal components, such as aerospace components. In particular, the present invention relates to methods for forming platinum aluminide diffusion coatings that provide corrosion and oxidation resistance.

A gas turbine engine typically consists of an inlet, a compressor, a combustor, a turbine, and an exhaust duct. The compressor draws in ambient air and increases its temperature and pressure. Fuel is added to the compressed air in the combustor, where it is burned to raise gas temperature, thereby imparting energy to the gas stream. To increase gas turbine engine efficiency, it is desirable to increase the temperature of the gas entering the turbine. This requires the first stage turbine vanes and rotor blades to be able to withstand the thermal and oxidation conditions of the high temperature combustion gas during the course of operation.

To protect the first stage turbine vanes and rotor blades from the extreme conditions, such components typically include coatings (e.g., aluminide and/or platinum aluminide coatings) that provide oxidation and corrosion resistance. While current platinum aluminide coatings provide suitable levels of protection, impurities in the coatings may reduce the attainable levels of oxidation resistance. For example, sulfur impurities in platinum aluminide coatings are known to reduce the oxidation resistances of the given coatings. As such, there is a need for a method for forming platinum aluminide coatings that contain low concentrations of sulfur.

### SUMMARY

The present invention relates to a method for forming a platinum aluminide coating on a substrate. The method includes forming a platinum-containing coating on the substrate, and performing a diffusion coating process with the use of an aluminum-based compound and a halide activator, where the aluminum-based compound and the halide activator each have a low concentration of sulfur, or are free of sulfur.

### BRIEF DESCRIPTION OF THE DRAWINGS

FIG. 1 is a sectional view of a metal component containing a platinum aluminide diffusion coating disposed on a substrate.

FIG. 2 is a flow diagram of a method for forming the platinum aluminide diffusion coating disposed on the substrate.

### DETAILED DESCRIPTION

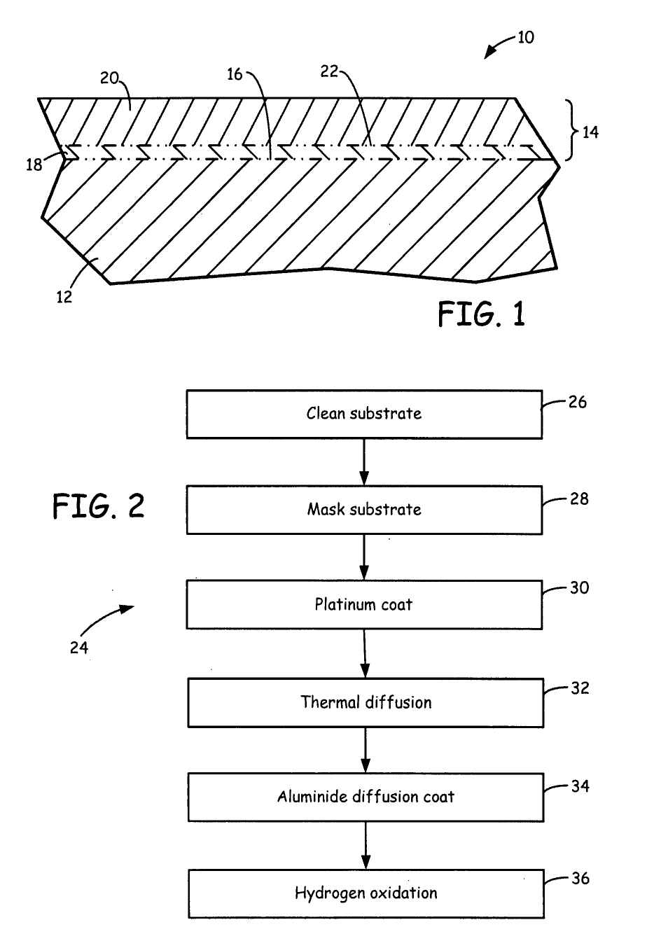

FIG. 1 is a sectional view of metal component 10, which includes substrate 12 and coating 14. Metal component 10 may be any type of component capable of containing coating 14, such as a turbine engine component. Substrate 12 is a metal substrate of metal component 10, and includes surface 16. Examples of suitable materials for substrate 12 include nickel, nickel-based alloys and superalloys, cobalt, cobalt-based alloys and superalloys, and combinations thereof, and may also include one or more additional materials such as carbon, titanium, chromium, niobium, hafnium, tantalum, molybdenum, tungsten, aluminum, and iron. Surface 16 is shown with a phantom line, and illustrates the original surface of substrate 12 before coating 14 is formed.

Coating 14 is a protective coating formed from subcoatings 18 and 20, pursuant to the present invention. Subcoating 18 is a platinum-based coating interdiffused with substrate 12 at surface 16, and includes surface 22. Surface 22 is also shown with a phantom line, and illustrates the original surface of subcoating 18 before subcoating 20 is formed. Subcoating 20 is an aluminide diffusion coating interdiffused with subcoating 18 at surface 22. Due to the interdiffusion between substrate 12 and subcoatings 18 and 20, the materials of substrate 12 and subcoatings 18 and 20 form one or more alloy gradients at surfaces 16 and 22. This effectively eliminates actual surfaces between substrate 12 and coating 14, and between subcoatings 18 and 20. Accordingly, the composition of coating 14 includes the materials from substrate 12 (e.g., nickel), platinum from subcoating 18, and aluminum from subcoating 20. As discussed below, coating 14 is also substantially free of sulfur, thereby enhancing the oxidation resistance of coating 14.

FIG. 2 is a flow diagram of method 24 for forming coating 14 on substrate 12. Method 24 includes steps 26-36, and initially involves cleaning surface 16 of substrate 12 (step 26). Because coating 14 is desirably substantially free of sulfur, surface 16 is desirably cleaned to remove any potential impurities (e.g., sulfur) located on surface 16. Examples of suitable cleaning techniques for step 26 include fluoride-ion treatments with hydrogen fluoride gas.

One or more portions of surface 16 may then be masked to prevent the formation of coating 14 over the masked portions of surface 16 (step 28). The masking process may be performed in a variety of manners, such as with condensation-curable maskants. In one embodiment, one or more portions of substrate 12 are masked with a composition disclosed in U.S. patent application Ser. No. 11/642,424, which is commonly assigned and hereby incorporated by reference, and entitled “Photocurable Maskant Composition and Method of Use”.

Substrate 12 is then platinum coated to form subcoating 18 (step 30). The platinum coating process is desirably performed with an electroplating process, which involves immersing substrate 12 in a bath that contains a plating solution. Suitable plating solutions include solutions of platinum-salts in carrier fluids. As used herein, the term “solution” refers to any suspension of particles in a carrier fluid (e.g., water), such as dissolutions, dispersions, emulsions, and combinations thereof. In one embodiment, the plating solution has a low concentration of sulfur, or more preferably, is free of sulfur. Examples of suitable concentrations of sulfur in the plating solution include less than about 20 ppm by weight, with particularly suitable concentrations of sulfur including less than about 10 ppm by weight, and with even more particularly suitable concentrations of sulfur including less than about 5 ppm by weight. The low concentrations or lack of sulfur in the plating solution reduce the amount of sulfur present in the resulting coating 14, thereby enhancing the oxidation resistance of coating 14.

When substrate 12 is immersed in the bath, a negative charge is placed on substrate 12 and a positive charge is placed on the plating solution. The positive charge causes the platinum-salts of the plating solution to disassociate, thereby forming positive-charged platinum ions in the carrier fluid. The negative charge placed on substrate 12 attracts the platinum ions toward surface 16, and reduces the positive charges on the platinum ions upon contact with substrate 12. This forms subcoating 18 bonded to surface 16.

The electroplating process is performed for a duration, and with a plating current magnitude, sufficient to build subcoating 18 to a desired thickness on surface 16. Suitable thicknesses for subcoating 18 after step 30 of method 24 range from about 25 micrometers to about 500 micrometers, with particularly suitable thicknesses ranging from about 130 micrometers to about 250 micrometers, where the thicknesses of subcoating 18 are measured between surface 16 of substrate 12 and surface 22 of subcoating 18. Examples of suitable processing conditions include a duration ranging from about one hour to about two hours at a plating current ranging from about 0.1 amperes to about 0.5 amperes. When subcoating 18 is formed, the negative and positive charges are removed from substrate 12 and the plating solution, respectively, and substrate 12 (including subcoating 18) is removed from the bath.

Substrate 12 (including subcoating 18) is then subjected to a thermal diffusion process to interdiffuse at least a portion of the platinum of subcoating 18 with the material of substrate 12 (step 32). In one embodiment, the thermal diffusion process involves placing substrate 12/subcoating 18 in a furnace and heating substrate 12/subcoating 18 to a sufficient temperature and for a sufficient duration to obtain a desired level of interdiffusion. The thermal treatment process is desirably performed for a suitable duration to interdiffuse the platinum of subcoating 18 with the materials of substrate 12, thereby effectively forming one or more alloy gradients along surface 16. Examples of suitable temperatures for the thermal diffusion process include temperatures ranging from about 930° C. (about 1700° F.) to about 1090° C. (about 2000° F.), with particularly suitable temperatures ranging from about 1040° C. (about 1900° F.) to about 1080° C. (about 1975° F.). Examples of suitable durations include at least about one hour, with particularly suitable durations ranging from about two hours to about four hours.

The interdiffused substrate 12/subcoating 18 is then subjected to an aluminide diffusion coating process, which desirably involves a pack cementation process (step 34). In one embodiment, the aluminide diffusion coating process involves placing the interdiffused substrate 12/subcoating 18 in a container (e.g., a retort) containing a powder mixture. The powder mixture includes an aluminum-based compound and a halide activator, where the aluminum-based compound and the halide activator each have a low concentration of sulfur, or more preferably, are free of sulfur. Examples of suitable concentrations of sulfur in each of the aluminum-based compound and the halide activator include less than about 20 ppm by weight, with particularly suitable concentrations of sulfur including less than about 10 ppm by weight, and with even more particularly suitable concentrations of sulfur including less than about 5 ppm by weight. The low concentrations or lack of sulfur in the aluminum-based compound and the halide activator allow the resulting subcoating 20 to also be substantially free of sulfur, thereby enhancing the oxidation resistance of coating 14.

The aluminum-based compound is a material that includes aluminum, and may be an aluminum-intermetallic compound. Examples of suitable aluminum-intermetallic compound for use in the diffusion coating process include chromium-aluminum (CrAl) alloys, cobalt-aluminum (CoAl) alloys, chromium-cobalt-aluminum (CrCoAl) alloys, and combinations thereof. Examples of suitable concentrations of the aluminum-based compound in the powder mixture range from about 1% by weight to about 40% by weight.

The halide activator is a compound capable of reacting with the aluminum-based compound during the diffusion coating process. Examples of suitable halide activators for use in the diffusion coating process include aluminum fluoride (AlF₃), ammonium fluoride (NH₄F), ammonium chloride (NH₄Cl), and combinations thereof. Examples of suitable concentrations of the halide activator in the powder mixture range from about 1% by weight to about 50% by weight.

The powder mixture may also include inert materials, such as aluminum oxide. The container may also include one or more gases (e.g., H₂ and argon) to obtain a desired pressure and reaction concentration during the diffusion coating process. The one or more gases are desirably clean gases (i.e., low concentrations of impurities) to reduce the risk of contaminating subcoating 20 during formation. In one embodiment, the one or more gases have a low combined concentration of sulfur, or more preferably, are free of sulfur. Examples of suitable concentrations of sulfur in the one or more gases include the concentrations discussed above for the aluminum-based compound and the halide activator. The use of clean gases, such as clean hydrogen, further cleans subcoating 20 during the diffusion coating process, thereby further reducing the concentration of sulfur in coating 14.

After the interdiffused substrate 12/subcoating 18 is placed in the container and packed in a bed of the powder mixture, the container is sealed to prevent the reactants from escaping the container during the diffusion coating process. The container is then heated (e.g., in a furnace), which heats substrate 12, subcoating 18, the aluminum-based compounds, the halide activators, and any additional materials in the container. The increased temperature initiates a reaction between the aluminum-based compounds and the halide activators to form gaseous aluminum-halide compounds. Suitable temperatures for initiating the reaction include temperatures ranging from about 650° C. (about 1200° F.) to about 1060° C. (about 2000° F.). The gaseous aluminum-halide compounds decompose at surface 22 of subcoating 18, thereby depositing aluminum on surface 22 to form subcoating 20. The deposition of the aluminum correspondingly releases the halide activator to form additional gaseous aluminum-halide compounds while the aluminum-based compounds are still available.

Due to the elevated temperature, the deposited aluminum is in a molten or partially molten state. This allows the aluminum to dissolve the material of subcoating 18 at surface 22, thereby causing the material of substrate 12, the material of subcoating 18, and at least a portion of the aluminum to interdiffuse to form coating 14. The aluminide diffusion coating process is continued until a desired thickness of coating 14 is formed on substrate 12. Suitable thicknesses of coating 14 for providing oxidation resistance to substrate 12 range from about 25 micrometers to about 125 micrometers, with particularly suitable thicknesses ranging from about 25 micrometers to about 75 micrometers. The thicknesses of coating 14 are measured from the location of surface 16 (i.e., prior to the thermal diffusion process of step 32). The diffusion coating process of step 34 may be discontinued by limiting the amount of aluminum-based compounds that are available to react with the halide activators, by reducing the temperature below the reaction-initiation temperature, or by a combination thereof. The resulting coating 14 is interdiffused into substrate 12, thereby allowing coating 14 to protect substrate 12 from corrosion and oxidation during use.

The interdiffusion causes a substantial portion of coating 14 to include the material of substrate 12, in addition to the platinum of subcoating 18 and the aluminum of subcoating 20. However, because the aluminum-based compounds and the halide activators contained low concentrations of sulfur (or were free of sulfur), coating 14 has a reduced concentration of sulfur, thereby enhancing the oxidation resistance of coating 14. As discussed above, the concentration of sulfur may be further reduced with the use of a plating solution that also contains a low concentration of sulfur (or is free of sulfur). The reduced-sulfur concentration allows metal component 10 to exhibit greater resistance against oxidization-causing conditions, such as those that occur during the course of operating gas turbine engines.

In an alternative embodiment, the thermal diffusion process of step 32 is omitted, and the interdiffusion of the material of substrate 12 and the platinum of subcoating 18 occurs during the aluminide diffusion coating process of step 34. In this embodiment, the interdiffusion of the aluminum of subcoating 20 causes the platinum of subcoating 18 to also interdiffuse with the materials of substrate 12, thereby forming one or more alloy gradients along surfaces 16 and 22.

To further enhance the oxidation resistance of coating 14, metal component 10 may subsequently undergo one or more hydrogen oxidation cycles to grow an oxide scale on coating 14 (step 36). Each hydrogen oxidation cycle involves heating metal component 10 in a dry hydrogen/oxygen atmosphere for a duration that is suitable for growing the oxide scale. Examples of suitable durations for each hydrogen oxidation cycle ranges from about 1 hour to about 5 hours. Examples of suitable temperatures for the hydrogen oxidation cycles range from about 900° C. to about 1000° C. The hydrogen used in the hydrogen oxidation cycles is beneficial for further cleaning coating 14, thereby further removing any potential impurities, and allows a substantially pure oxide scale to be grown.

After coating 14 is formed, metal component 10 may then undergo additional process steps. For example, a thermal-barrier coating may be deposited onto coating 14 to protect coating 14 and substrate 12 from extreme temperatures. Suitable thermal-barrier coatings include ceramic-based layers formed on coating 14 with standard deposition techniques (e.g., physical vapor deposition and plasma spray techniques). The composition of coating 14 (e.g., NiAlPt) is particularly suitable for functioning as a bonding surface for the thermal-barrier coating, particularly with the formation of an oxide scale. Thus, in addition to providing oxidation and corrosion protection, coating 14 formed pursuant to the present invention is also suitable for functioning as a bond layer for a thermal-barrier coating.

Although the present invention has been described with reference to preferred embodiments, workers skilled in the art will recognize that changes may be made in form and detail without departing from the spirit and scope of the invention.

1. A method for forming a platinum aluminide coating on a substrate, the method comprising:
forming a platinum-containing coating on the substrate;
exposing the platinum-containing coating to an aluminum-based compound and a halide activator, the aluminum-based compound and the halide activator each having a sulfur concentration of less than about 20 parts-per-million by weight; and
performing a diffusion coating process on the platinum-containing coating with the aluminum-based compound and the halide activator.

2. The method of claim 1, wherein the sulfur concentration of at least one of the aluminum-based compound and the halide activator is less than about 10 parts-per-million by weight sulfur.

3. The method of claim 2, wherein the sulfur concentration of the at least one of the aluminum-based compound and the halide activator is less than about 5 parts-per-million by weight sulfur.

4. The method of claim 1, wherein forming the platinum-containing coating on the substrate comprises electroplating the substrate.

5. The method of claim 4, wherein the electroplating is performed with a plating solution having a sulfur concentration of less than about 20 parts-per-million by weight.

6. The method of claim 1, wherein the aluminum-based compound is selected from the group consisting of chromium-aluminum (CrAl) alloys, cobalt-aluminum (CoAl) alloys, chromium-cobalt-aluminum (CrCoAl) alloys, and combinations thereof.

7. The method of claim 1, wherein the halide activator is selected from the group consisting of aluminum fluoride, ammonium fluoride, ammonium chloride, and combinations thereof.

8. The method of claim 1, wherein the substrate comprises a material selected from the group consisting of nickel-based alloys, nickel-based superalloys, cobalt-based alloys, cobalt-based superalloys, and combinations thereof.

9. The method of claim 1, further comprising exposing the platinum aluminide coating to at least one hydrogen oxidation cycle.

10. A method for forming a platinum aluminide coating on a substrate, the method comprising:
forming a platinum coating on the substrate;
interdiffusing at least a portion of the platinum coating and the substrate, thereby forming an interdiffused substrate;
reacting an aluminum-based compound and a halide activator to form an aluminum-halide compound, wherein the aluminum-based compound and the halide activator each have a sulfur concentration of less than about 20 parts-per-million by weight; and
interdiffusing aluminum from the aluminum-halide compound into the interdiffused substrate.

11. The method of claim 10, wherein the sulfur concentration of at least one of the aluminum-based compound and the halide activator is less than about 10 parts-per-million by weight sulfur.

12. The method of claim 11, wherein the sulfur concentration of the at least one of the aluminum-based compound and the halide activator is less than about 5 parts-per-million by weight sulfur.

13. The method of claim 10, wherein forming the platinum coating on the substrate comprises electroplating the substrate with a plating solution having a sulfur concentration of less than about 20 parts-per-million by weight.

14. The method of claim 10, further comprising exposing the substrate to at least one hydrogen oxidation cycle.

15. A method for forming an aluminide coating on a substrate, the method comprising:
forming a platinum-containing coating on the substrate;
placing the substrate with the platinum-containing coating in a container;
introducing an aluminum-based compound and a halide activator into a container, the aluminum-based compound and the halide activator each having a sulfur concentration of less than about 20 parts-per-million by weight;
forming an aluminum-halide compound from the aluminum-based compound and the halide activator; and
depositing aluminum from the aluminum-halide compound onto the platinum-containing coating.

16. The method of claim 15, wherein the sulfur concentration of at least one of the aluminum-based compound and the halide activator is less than about 10 parts-per-million by weight sulfur.

17. The method of claim 16, wherein the sulfur concentration of the at least one of the aluminum-based compound and the halide activator is less than about 5 parts-per-million by weight sulfur.

18. The method of claim 15, wherein forming the platinum-containing coating on the substrate comprises electroplating the substrate with a plating solution having a sulfur concentration of less than about 20 parts-per-million by weight.

19. The method of claim 15, wherein the substrate comprises a material selected from the group consisting of nickel-based alloys, nickel-based superalloys, cobalt-based alloys, cobalt-based superalloys, and combinations thereof.

20. The method of claim 15, further comprising exposing the substrate to at least one hydrogen oxidation cycle.
